(19) United States
(12) Patent Application Publication
(10) Pub. No.: US 2007/0040649 A1
(43) Pub. Date: Feb. 22, 2007

(54) Multifunction keyless entry system

(75) Inventors: James Dulgerian, Troy, MI (US); Nathan Lucas, Shelby Township, MI (US); Eric Strebel, Southfield, MI (US); Roy Taylor, Flint, MI (US); Brent Huggler, Lapeer, MI (US)

Correspondence Address: BRINKS HOFER GILSON & LIONE, P.O. BOX 10395, CHICAGO, IL, 60610, US

(73) Assignee: ALPS AUTOMOTIVE, INC.

(21) Appl. No.: 11/205,993

(22) Filed: Aug. 17, 2005

(51) Int. Cl. G05B 19/00

(52) U.S. Cl. 340/5.64; 340/5.72

(57) ABSTRACT

A remote keyless entry (RKE) system performs multiple functions in a vehicle. One function is to respond to RKE controller keypresses to lock or unlock doors, to start an engine, or to arm or deactivate an alarm. A second function is to interpret RKE controller keypresses as accessory control commands. The RKE controller thereby provides a convenient accessory controller. In addition, the RKE controller may also supplement or take the place of pre-existing dedicated accessory controllers, such as controllers for a radio, video game, or DVD player, to relieve the burden of locating and operating those accessory controllers.

### BACKGROUND OF THE INVENTION

1. Technical Field

This invention relates to remote keyless entry systems for vehicles. More specifically, this invention relates to a remote keyless entry system with capabilities which extend beyond the primary functions of a keyless entry system, such as locking and unlocking vehicle doors.

2. Related Art

At one time, only simple mechanical keys were used to lock or unlock vehicle doors and start the vehicle engine. While mechanical keys remain present in virtually all vehicles on the road today, vehicle manufacturers now provide more advanced alternatives. In particular, many vehicles now provide sophisticated remote keyless entry (RKE) systems.

The RKE system in the vehicle interacts with what is commonly referred to as a “fob” or “key fob” which acts as a portable RKE controller. The RKE controller includes control buttons which, when pressed, instruct the vehicle to lock doors, unlock doors, or start the engine, as examples. To that end, the RKE controller includes a wireless transmitter which communicates RKE controller button presses to the vehicle for processing.

Once the vehicle is unlocked and the driver enters the vehicle, the RKE controller is generally of no further use. Instead, the keyless entry system and the RKE controller remain passive until the driver exits the vehicle and uses the RKE controller to once again lock or unlock the doors or start the engine. As a result, the sophisticated processing and wireless communication capabilities of the remote keyless entry system are underutilized and are idle for significant periods of time.

### SUMMARY

This invention provides a remote keyless entry (RKE) system which combines accessory control and remote keyless entry functions in one RKE controller. In a primary role, the RKE system responds to RKE controller key presses to lock or unlock doors, to start an engine, to arm or deactivate an alarm, or take other actions traditionally associated with a remote keyless entry system. In addition, however, the RKE system fulfils a secondary role: interpreting RKE controller key presses as accessory control commands. Thus, the RKE controller may provide a convenient accessory controller or may take the place of other accessory controllers which a passenger would ordinarily be burdened with locating and operating to control accessory systems in the vehicle.

The RKE system receives an RKE controller keypress message. The keypress message encodes an RKE controller keypress, such as ‘Door Lock’, ‘Door Unlock’, or ‘Engine Start’ keypress. In addition, the RKE system obtains an RKE controller location associated with the RKE controller keypress message. As examples, the RKE controller location may be inside the vehicle, outside the vehicle, or may be expressed in terms of another boundary.

The RKE system establishes primary actions that may be taken for any given RKE keypress. As examples, the primary action for a ‘Door Unlock’ keypress may be to unlock the driver's side door, while the primary action for an ‘Engine Start’ keypress is to the start the vehicle engine. In addition, the RKE system establishes secondary actions for the same RKE keypresses. For example, the secondary actions for the ‘Door Unlock’ keypress may be a volume increase or decrease action, play and pause control actions for a DVD player, CD player, or other accessory device, or any other entertainment device control action.

The RKE system determines whether to initiate the primary action or the accessory action depending on the RKE controller location. When the RKE controller is outside the vehicle, the RKE system may initiate the primary action associated with any given RKE controller keypress. On the other hand, when the RKE controller is inside the vehicle, the RKE system may initiate the accessory action associated with an RKE controller keypress.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows a remote keyless entry (RKE) system in a vehicle and an RKE controller interacting with the RKE system.

FIG. 2 shows RKE controller circuitry.

FIG. 3 shows an RKE system.

FIG. 4 shows a primary mapping between RKE keypresses and primary actions.

FIG. 5 shows a secondary mapping between RKE keypresses and accessory actions.

FIG. 6 shows an RKE system in communication over a vehicle bus with control modules.

FIG. 7 shows acts that the RKE system may take to process RKE keypress messages.

### DETAILED DESCRIPTION OF THE PREFERRED EMBODIMENTS

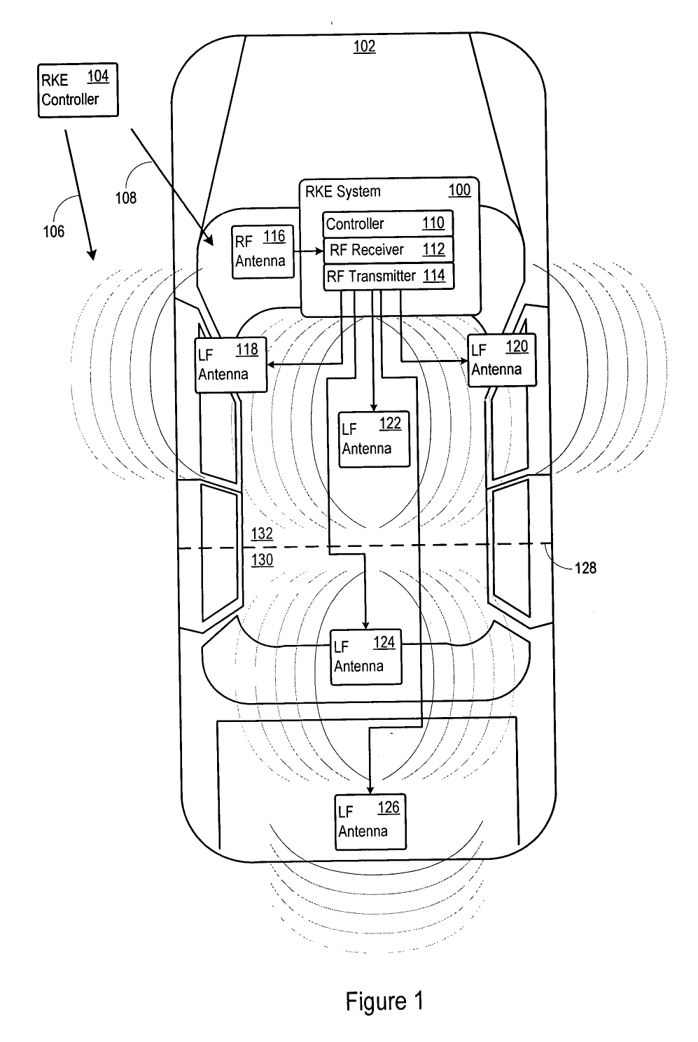

FIG. 1 shows a remote keyless entry (RKE) system 100 in a vehicle 102. The RKE system 100 communicates with an RKE controller 104. The RKE controller 104 communicates with the RKE system 100 using radio frequency (RF) transmission and reception of messages 106 and 108 to one or more RF antennae in the vehicle 102.

The RKE system 100 includes a controller 110, an RF receiver 112, and an RF transmitter 114. The RKE system 100 connects to antennae positioned in the vehicle 102. The antennae may include an RF antenna 116, through which the RKE system 100 communicates bi-directionally with the RKE controller 104 at frequencies centered at 315 MHz, 433.92 MHz, 868 MHz, or at other frequency centers. In addition, the RKE system 100 may connect to one or more low frequency (LF) antennae, such as the LF antennae 118, 120, 122, 124, and 126. The LF antennae communicate at frequencies centered at 125 KHz or other frequency centers. Additional or fewer RF and LF antennae may be used in other implementations.

The LF antennae 118-126 are positioned in the vehicle 102 to support communication with the RKE controller 104 at several strategic locations. For example, the LF antenna 118 communicates with the RKE controller 104 when the RKE controller 104 is outside the vehicle and near the left door. Similarly, the LF antenna 120 and the LF antenna 126 communicate with the RKE controller 104 when the RKE controller 104 is outside the vehicle and near the right door and the trunk, respectively. In other words, the LF antenna 118, 120, and 126 support short range communication with the RKE controller 104 when the RKE controller 104 is outside the vehicle.

The LF antenna 118, 120, and 126 may be part of a passive entry system. For example, a door handle pull or other input may alert (e.g., wake up) a door control module. The door control module may then send an LF signal from the corresponding LF antenna 118, or 120. When the RKE controller 104 is close enough to receive the LF signal, the RKE controller 104 receives the LF signal and responsively transmits an encrypted RF signal.

The encrypted RF signal may include a module identifier which specifies the door module from which the LF signal issued. The RKE system 100 receives the encrypted RF signal at the RF antenna 116. After receiving, decrypting, and validating the message, the RKE system 100 sends a command over a vehicle communications bus which directs the specified door module to unlock the door.

Some of the LF antennae may be used for purposes other than passive entry. In FIG. 1, for example, the LF antenna 122 and 124 are positioned in the vehicle interior and generally provide a communication range approximately bounded by the interior of the vehicle 102. Accordingly, interior control modules connected to the LF antennae 122 and 124 may communicate with the RKE controller 104 when the RKE controller 104 is inside the vehicle.

One capability in part provided by the LF antennae 122 and 124 is determining whether the RKE controller 104 is inside the vehicle or outside the vehicle. For example, when a vehicle door opens or closes (e.g., when the driver has entered the vehicle), the interior modules may transmit an interior LF signal from their antennae 122 and 124. The interior modules may transmit at other times, however, such as on a regular schedule (e.g., once per minute), when the vehicle begins to move, when a radio is turned on, or at any other time when the interior modules will check communication with the RKE controller 104.

LF transmissions from any of the LF antenna 118-126 may include a seed (e.g., a random number). The RKE controller 104 may use the seed in place of a rolling code in a responsive RF transmission. The RKE system 100 controls which seed is transmitted from each LF antenna 118-126. Accordingly, the RF receiver 112 may determine to which LF antenna 118-126 the RKE controller 104 is responding.

When the RKE controller 104 is close enough (e.g., inside the vehicle) to receive an interior LF signal transmitted by any interior LF antenna, the RKE controller 104 may transmit a responsive RF signal. The responsive RF signal, optionally encrypted, may include an interior module identifier which specifies the interior module from which the interior LF signal issued. The RKE controller 104 may obtain the interior module identifier from the interior LF signal transmitted by the interior LF module. In particular, the RKE controller 104 may use the seed in the LF signal as an interior module identifier.

The RKE system 100 receives the responsive RF signal at the RF antenna 116. After receiving, decrypting, and validating the message, the RKE system 100 checks the module identifier in the responsive RF signal. When the module identifier matches an interior module identifier, the RKE system 100 may conclude that the RKE controller 104 is inside the vehicle, or within any other boundary set by the LF antennae 122 and 124. When the module identifier is not an interior module identifier, the RKE system may conclude that the RKE controller 104 is outside the vehicle, or outside any other boundary set by the LF antennae 122 and 124. Thus, the responsive RF signal may be regarded as an RKE location message which the RKE system 100 may process to determine an RKE location. The RKE system 100 may determine the RKE controller location in other manners, however.

The RKE system 100 may divide the interior of the vehicle into zones. The RKE controller 104 may provide different functionality depending on the zone in which it is currently located. FIG. 1 shows an example in which a boundary 128 establishes a game zone 130 and a movie zone 132. Any other zones associated with any other functionality may be established in the vehicle 102, such as a front seat zone, rear seat zone, or any other zone.

Inside the game zone 130, the vehicle 102 may provide a video game system. Inside the movie zone 132, the vehicle 102 may provide a DVD player. When the module identifier in the responsive RF signal includes the identifier of the interior module connected to the LF antenna 124, the RKE system 100 may conclude that the RKE controller 104 is within the game zone 130. Similarly, when the module identifier in the responsive RF signal includes the identifier of the interior module connected to the LF antenna 122, the RKE system 100 may conclude that the RKE controller 104 is within the movie zone 132.

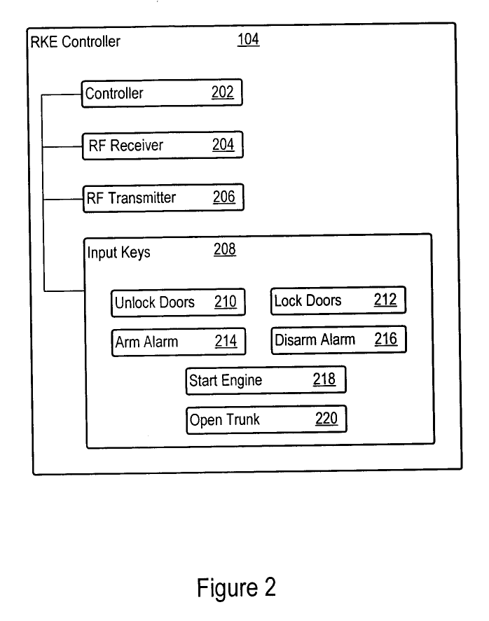

FIG. 2 shows a block diagram of the RKE controller 104. A controller 202 (e.g., a microcontroller) coordinates the operation of the RF receiver 204, RF transmitter 206, and the input keys 208. When the operator presses an input key 208, the RKE controller 104 prepares and transmits an encrypted RF message to the RKE system 100.

In the example shown in FIG. 2, the input keys 208 include an ‘Unlock Doors’ key 210 and a ‘Lock Doors’ key 212, which request the vehicle 102 to unlock or lock its doors, respectively. The input keys 208 also include an ‘Arm Alarm’ key 214 and a ‘Disarm Alarm’ key 216 which instruct the vehicle to activate its alarm or deactivate its alarm, respectively. Some RKE controllers may also include a ‘Start Engine’ key 218 for requesting a remote start of the vehicle engine, and an ‘Open Trunk’ key 220 which requests the vehicle to unlock and/or open the vehicle trunk. The input keys 208 may vary widely between RKE controllers, and more or fewer keys may be provided in any given RKE controller.

More specifically, in response to a keypress, the controller 202 may wake up and send message data to the RF transmitter 206. The RF transmitter 206 sends an RKE controller keypress message to the RKE system 100. The RKE controller keypress message may be, as examples, 64 or 128 bits long, and may include a preamble, command code, RKE controller serial number, rolling code, and/or other message data. The command code may identify an RKE keypress (e.g., a ‘Door Unlock’ keypress). The rolling code may be incremented on each button push and subsequent RF transmission and may be employed to encrypt the RF transmission. The RF signal may be a modulated signal, such as an Amplitude Shift Keying (ASK) modulated signal, Phase Shift Keying (PSK) modulated signal, or may take other forms.

The RKE controller 100 receives the RKE controller keypress message transmitted from the RKE controller 104. The RF receiver 112 captures the RF signal bearing the RKE keypress message, demodulates the RF signal, and sends the recovered data stream to the controller 110. The controller 110, in response, decodes the data stream to determine the key pressed on the RKE controller 104. For example, the command code, or other code in the data stream, may specify an RKE keypress. Having determined the RKE keypress, the RKE system 100 sends one or more responsive commands to one or more control modules over a vehicle communication bus. For example, in response to a ‘Door Unlock’ keypress, the RKE system 100 may send an ‘Unlock’ message to a door module.

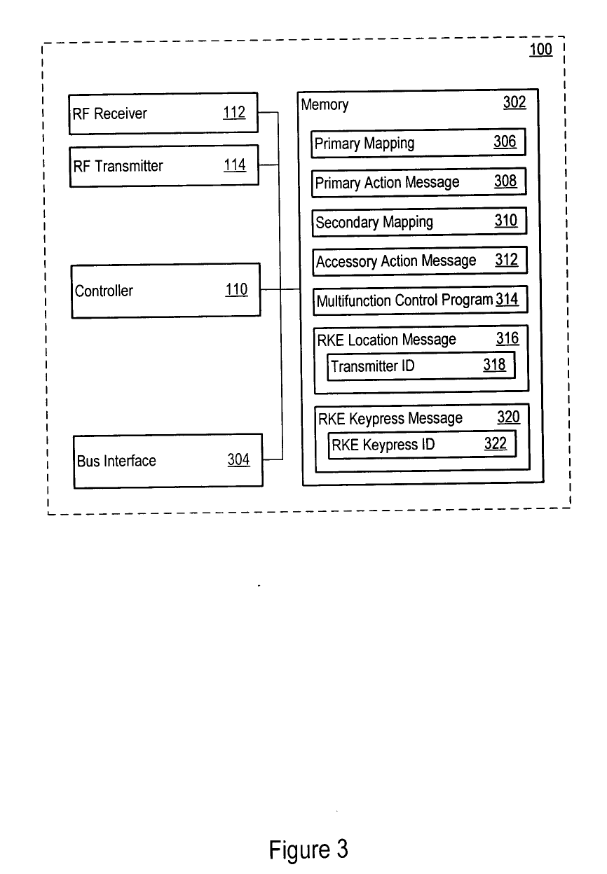

FIG. 3 shows additional aspects of the RKE system 100. In FIG. 3, the RKE controller 110 connects to a memory 302 and a vehicle bus communication interface 304. The communication interface 304 may be a Controller Area Network (CAN) interface, a Local Interconnection Network (LIN) interface, Media Oriented Systems Transport (MOST) interface, or other type of communication interface. The controller 110 prepares, sends, and receives messages through the interface 304 according to the communication protocol and the message formats implemented in the vehicle communication network.

The memory 302 may serve as program and data memory for the controller 110. More specifically, the memory 302 establishes a primary mapping 306 between RKE keypresses (e.g., an ‘Unlock Door’ keypress) and primary actions. The primary action may include sending any responsive primary action message 308 (e.g., an ‘Unlock’ message) to a primary control module (e.g., a door controller) in the vehicle. The memory 302 also establishes one or more secondary mappings 310 between the same RKE keypresses and accessory actions. The accessory actions may include sending any responsive secondary action message 312 (e.g., a ‘Volume Increase’ message) to an accessory control module (e.g., a radio control module).

Multiple secondary mappings may be established in the RKE system 100. Each secondary mapping may map RKE keypresses to control actions for a specific vehicle accessory (e.g., to control actions a radio, DVD player, music player, game system, mobile phone, GPS system, or other accessory). Alternatively, a secondary mapping may specify control actions for multiple vehicle accessories. Furthermore, one or more secondary mappings may be applicable to specific zones or locations within the vehicle 102.

Continuing the example given above in FIG. 1, the memory 302 may establish a secondary mapping applicable when the RKE controller 104 is in the game zone 130, and a secondary mapping applicable when the RKE controller 104 is in the movie zone 132. The game zone mapping may translate the RKE keys into game controls (e.g., move left, right, fire, or any other control). The movie zone mapping may translate the RKE keys into entertainment device controls (e.g., DVD play and DVD pause controls).

The RKE controller operator may select which secondary mapping is active by submitting a mapping selection input to the RKE system 100 or vehicle 102. Alternatively, the vehicle 102 may choose a particular secondary mapping (e.g., a second mapping which includes radio control actions) as the default active mapping. In addition, the RKE system 100 may determine the applicable secondary mapping based on the location of the RKE controller 104 within the vehicle 102.

The decision of whether a primary action or a secondary action will be taken may be based on the location of the RKE controller 104. When the RKE controller 104 is outside the vehicle 102, the primary actions may be taken in response to RKE keypresses. When the RKE controller 104 is inside the vehicle 102, the secondary actions may be taken in response to RKE keypresses.

The controller 110 executes a multifunction control program 314 in the memory. The control program 314 may determine the RKE controller location based on an RKE location message 316 and, for example, a transmitter identifier 318 communicated by the RKE location message 316. The RKE location message 316 may be any message which the RKE controller 104 sends to the RKE system 100 which includes a transmitter identifier 318. The control program 314 may then determine which action to take based on an RKE keypress message 320 and an RKE keypress identifier 322 communicated by the RKE keypress message 320.

In particular, the multifunction control program 314 includes instructions executed by the controller 110 which cause the RKE system 100 to receive the RKE location message 316 (e.g., from the RF receiver 112) and extract the transmitter identifier 318. The controller 110 checks the transmitter identifier 318 against identifiers associated with the modules in the vehicle 102. When the transmitter identifier 318 corresponds to an interior module, such as the interior modules connected to the interior LF antennae 122 or 124, the controller 110 determines that the RKE controller location is ‘Inside Vehicle’. Otherwise, the controller 110 determines that the RKE controller location is ‘Outside Vehicle’.

The multifunction control program 314 also causes the RKE system 100 to receive the RKE keypress message 320 and extract the RKE keypress identifier 322. The RKE keypress identifier 322 distinguishes between the multiple RKE input keys 208. Depending on the RKE controller location, any given RKE input key may cause the RKE system 100 to initiate one of multiple possible responsive actions.

For example, when the RKE controller location is ‘Outside Vehicle’, the controller 110 may select from the primary actions in the primary mapping 306, based on the RKE keypress 322. The controller 110 may then prepare and initiate transmission of a corresponding primary action message through the automotive bus interface 304. Similarly, when the RKE controller location is ‘Inside Vehicle’, the controller 110 may select from the accessory actions in the secondary mapping 310 based on the RKE keypress 322. The controller 110 prepares and initiates transmission of a corresponding accessory action message through the automotive bus interface 304.

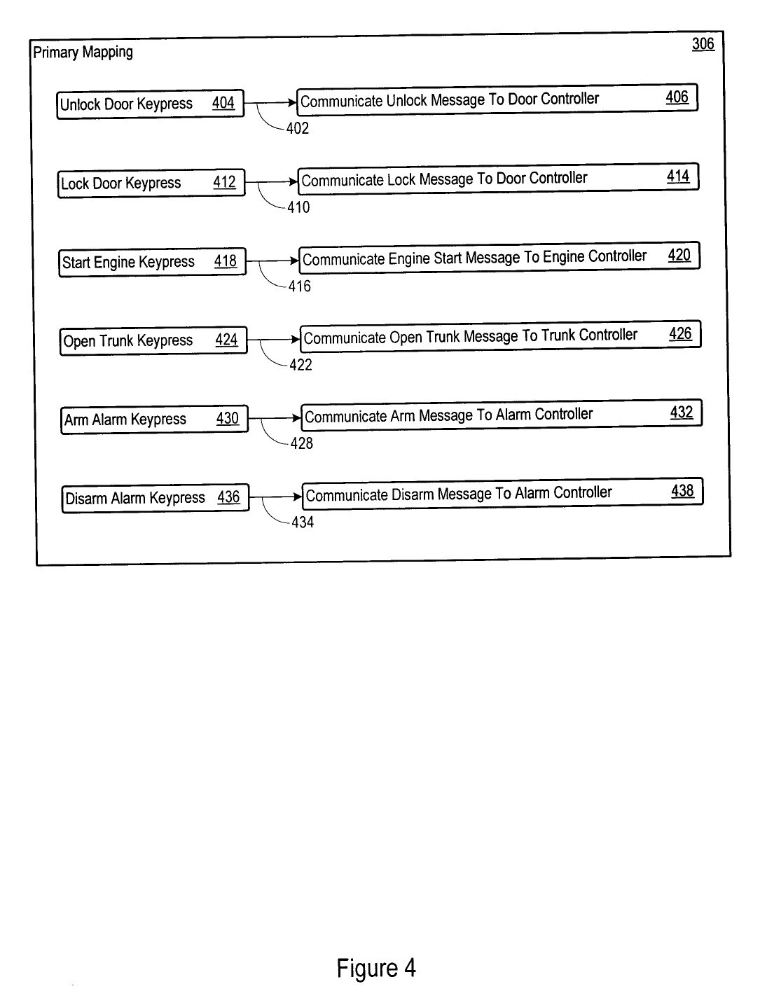

FIG. 4 shows an example of the primary mapping 306 between keypresses and responsive actions. As shown in FIG. 4, the primary mapping 306 establishes a mapping 402 from the ‘Unlock Door’ keypress 404 to the responsive action 406: ‘Communicate Unlock Message’ to the door controller. Additional primary mappings are also established, including: a mapping 410 from the ‘Lock Door’ keypress 412 to the responsive action 414: ‘Communicate Lock Message’ to the door controller; a mapping 416 from the ‘Start Engine’ keypress 418 to the responsive action 420: ‘Communicate Engine Start Message’ to the engine controller; a mapping 422 from the ‘Open Trunk’ keypress 424 to the responsive action 426: ‘Communicate Open Trunk Message’ to the trunk controller; a mapping 428 from the ‘Arm Alarm’ keypress 430 to the responsive action 432: ‘Communicate Arm Message’ to the vehicle alarm controller; a mapping 434 from the ‘Disarm Alarm’ keypress 436 to the responsive action 438: ‘Communicate Disarm Message’ to the vehicle alarm controller. Any other primary actions may be established for the RKE keypresses.

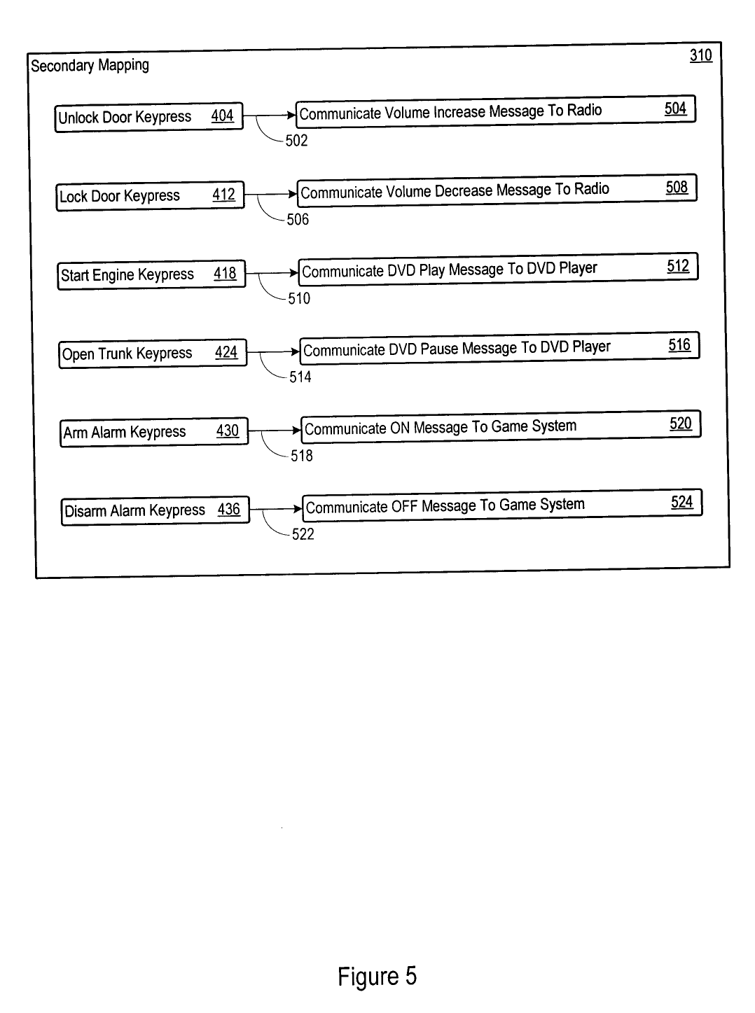

FIG. 5 shows an example of the secondary mapping 308 between keypresses and responsive secondary actions. In the example shown in FIG. 5, the secondary actions are control messages for entertainment systems in the vehicle. However, the secondary actions may be any other action for any vehicle component.

As shown in FIG. 5, the secondary mapping 308 establishes a mapping 502 from the ‘Unlock Door’ keypress 404 to the responsive action 504: ‘Communicate Volume Increase Message’ to the radio module. Additional secondary mapping are also established, including: a mapping 506 from the ‘Lock Door’ keypress 412 to the responsive action 508: ‘Communicate Volume Decrease Message to the radio module; a mapping 510 from the ‘Start Engine’ keypress 418 to the responsive action 512: ‘Communicate DVD Play Message’ to the DVD player; a mapping 514 from the ‘Open Trunk’ keypress 424 to the responsive action 516: ‘Communicate DVD Pause Message’ to the DVD player; a mapping 518 from the ‘Arm Alarm’ keypress 430 to the responsive action 520: ‘Communicate Power ON Message’ to the vehicle game system; a mapping 522 from the ‘Disarm Alarm’ keypress 436 to the responsive action 524: ‘Communicate Power OFF Message’ to the vehicle game system. Any other secondary actions may be established for the RKE keypresses.

The primary mapping 306 and/or secondary mapping 308 may be established as lookup tables in the memory 302. Alternatively or additionally, the mappings 306, 308 may be established in the control program 314 as logical tests, functions, or branch instructions. Other implementations of the mappings 306 and 308 may also be employed.

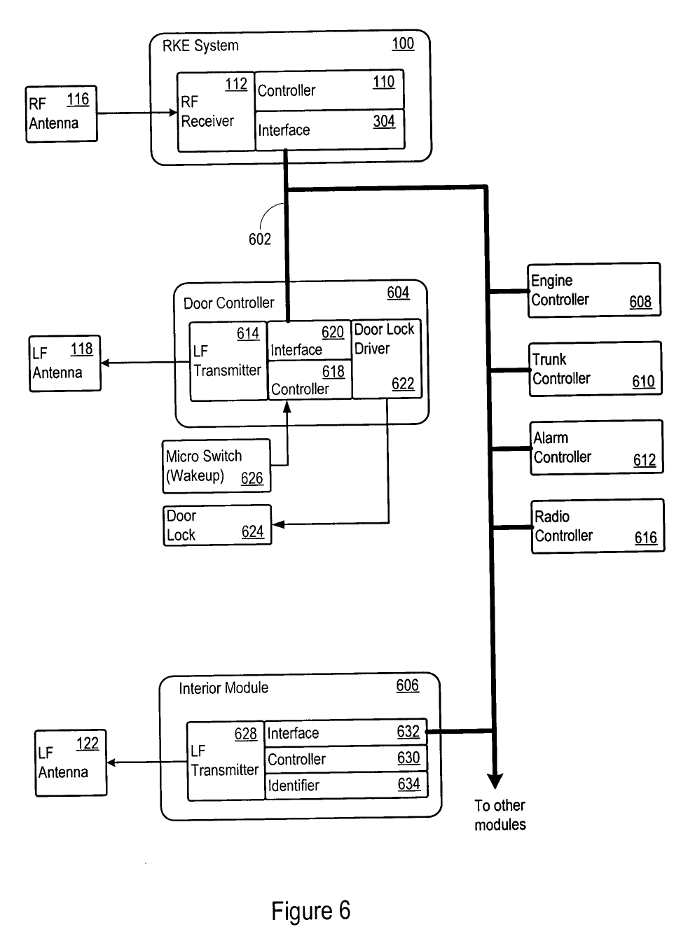

FIG. 6 shows an RKE system 100 in communication over a vehicle bus 602 with control modules which are also connected to the vehicle bus 602. In the example shown in FIG. 6, the control modules include a door control module 604, an interior module 606, and an engine control module 608. A trunk control module 610, an alarm control module 612, and a radio control module 616 are also present. Other vehicles may provide additional or fewer control modules. Each module may include a controller, memory, control programs, or any other control circuitry or logic which implements the actions (e.g., increasing radio volume) for which the module is responsible.

The door control module 604 includes an LF transmitter 614 connected to the LF antenna 118 for the front left door. A door module controller 618 coordinates the operation of the door control module 604 and sends and receives messages over a vehicle communication bus interface 620. For example, the controller 618 may receive a ‘Door Lock’ or ‘Door Unlock’ message through the interface 620 and responsively control a door lock driver 622 to lock or unlock a door lock 624.

The door controller 618 may also receive input from a wakeup switch 626. The wakeup switch 626 may be connected to the door handle, and may signal the controller 618 when the driver or other individual has lifted the door handle to gain access to the vehicle. In connection with the passive entry technique described above, the wakeup switch 626 may signal the controller 618 to transmit an LF signal for passive entry to the RKE controller 104.

The interior module 606 includes an LF transmitter 628 connected to the interior LF antenna 122. The controller 630 receives and transmits messages over a vehicle communication bus interface 632. The interior module 606 also includes a controller 630 which directs the LF transmitter 628 to determine, for example, whether the RKE controller 104 is inside the vehicle.

To that end, the interior module 606 may be assigned an identifier 634. For example, the identifier 634 may be a pre-defined bit pattern which the RKE system 100 recognizes as an identifier assigned to an interior module. Accordingly, when the RKE system 100 receives a message from the RKE controller 104 which includes the identifier 634, the RKE system 100 may consider the RKE controller 104 to be inside the vehicle 102.

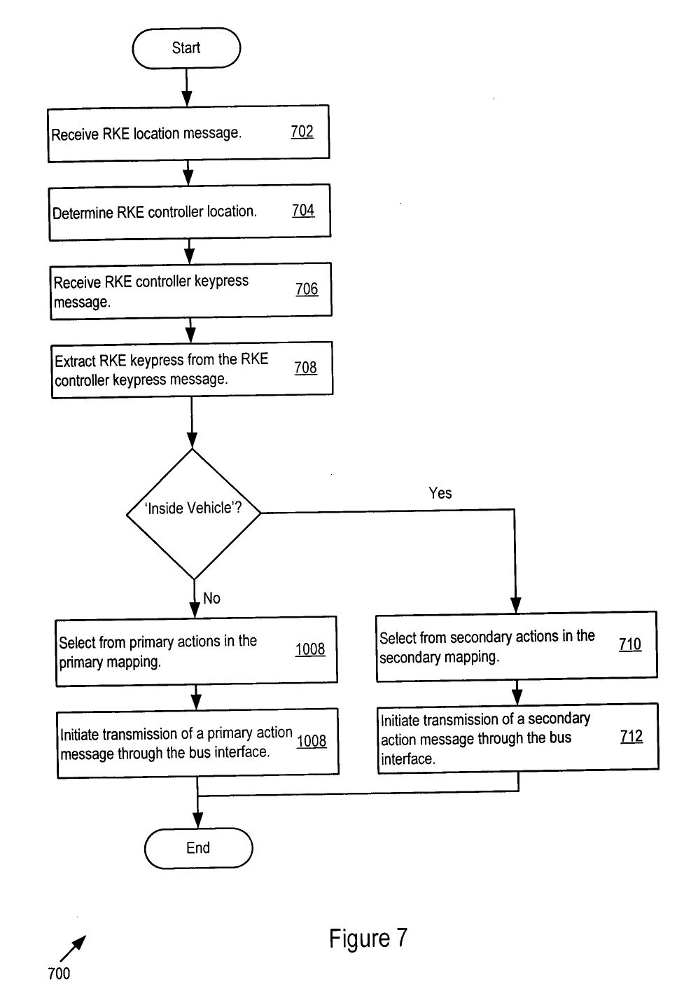

FIG. 7 shows acts 700 that the RKE system 100 and control program 314 may take to process RKE keypress messages. The RKE system 100 receives an RKE location message 316 (Act 702) and determines an RKE controller location (Act 704). To that end, the control program 314 may extract a module identifier 318 from the RKE location message 316 and compare the identifier to identifiers assigned to interior modules. When the extracted identifier matches an identifier assigned to an interior module, the RKE system 100 may determine that the RKE controller 104 is inside the vehicle.

In addition, the RKE system 100 receives an RKE controller keypress message 320 (Act 706). The control program 134 extracts an RKE keypress identifier 322 from the keypress message 320 (Act 708). When the RKE controller location is inside the vehicle, the control program 314 selects from secondary actions in the secondary mapping 310 (Act 710). The control program 314 then initiates transmission of a secondary action message through the bus interface 304 to the vehicle module responsible for executing the secondary action.

However, when the RKE controller 104 is outside the vehicle, the RKE controller keys 208 operate in their primary role. Thus, when the RKE system 100 determines that the RKE controller 104 is outside the vehicle, the control program 314 selects from primary actions in the primary mapping 308. The control program 314 then initiates transmission of a primary action message through the bus interface 304 to the vehicle module responsible for executing the primary action.

The vehicle 102 may transmit an LF signal from the interior antennae 122 and 124 to check the location of the RKE controller 104 at any interval. For example, the vehicle 102 may poll for the presence of the RKE controller 104 inside the vehicle 102 every second, every 10 seconds, or at any other interval. When the RKE controller 104 remains inside the vehicle (or inside any given zone), the RKE system 100 may react to RKE keypresses with the accessory actions. When the RKE controller 104 is not found within the vehicle 102, the RKE system 100 may revert to the primary mode of operation for the RKE controller 104.

The RKE controller 104 thereby performs multiple functions in the vehicle 102. One primary function is to provide RKE controller keypresses to lock or unlock doors, to start an engine, or to arm or deactivate an alarm. A second function is to provide RKE controller keypresses to control vehicle accessories. In other words, the RKE controller 104 provides a convenient accessory controller which may also supplement or take the place of pre-existing dedicated accessory controllers, such as controllers for a radio, video game, or DVD player. The RKE system 100 thereby helps to relieve the burden of locating and operating multiple independent accessory controllers for the vehicle 102.

While various embodiments of the invention have been described, it will be apparent to those of ordinary skill in the art that many more embodiments and implementations are possible within the scope of the invention. For example, a secondary mapping may be established to control an MP3 or other music player. The secondary mapping may include mappings from RKE keys 208 to play, fast forward, previous song, next song, pause, and other MP3 player commands. Accordingly, the invention is not to be restricted except in light of the attached claims and their equivalents.

We claim:

1. A remote keyless entry system comprising:
a wireless receiver operable to receive a remote keyless entry (RKE) controller keypress message; and
control logic coupled to the wireless receiver that:
determines an RKE controller location; and
selects from multiple different available responses to the RKE controller keypress message based on the RKE controller location.

2. The remote keyless entry system of claim 1, where the RKE location is one of ‘Inside Vehicle’ and ‘Outside Vehicle’.

3. The remote keyless entry system of claim 1, where the multiple available responses include issuing an accessory control message.

4. The remote keyless entry system of claim 3, where the accessory control message comprises an audio system control command or an entertainment device control command.

5. The remote keyless entry system of claim 1, where the wireless receiver is further operable to receive an RKE location message, and where the control logic determines the RKE controller location based on the RKE location message.

6. The remote keyless entry system of claim 1, where the control logic further:
determines an RKE controller keypress based on the RKE controller keypress message; and
selects from the multiple different available responses based on the RKE controller location and the RKE controller keypress.

7. The remote keyless entry system of claim 6, where the RKE controller keypress and the RKE controller location distinguish between a vehicle door lock response and an accessory control command response.

8. The remote keyless entry system of claim 6, where the RKE controller keypress and the RKE controller location distinguish between an engine start response and an accessory control command response.

9. The remote keyless entry system of claim 6, where the RKE controller keypress and the RKE controller location distinguish between an alarm configuration response and an accessory control command response.

10. A method for responding to a remote keyless entry (RKE) controller keypress message, the method comprising:
receiving an RKE controller keypress message specifying an RKE keypress;
obtaining an RKE controller location associated with the RKE controller keypress message;
establishing a primary action and a secondary action associated with the RKE keypress; and
initiating execution of the secondary action responsive to the RKE keypress based on the RKE controller location.

11. The method of claim 10, where the secondary action comprises:
transmitting an entertainment device control message.

12. The method of claim 10, where initiating execution comprises:
initiating execution of the secondary action when the RKE controller location is ‘Inside Vehicle’.

13. The method of claim 10, where establishing comprises:
establishing a door lock action as the primary action for the RKE keypress.

14. The method of claim 10, where establishing comprises:
establishing an engine start action as the primary action for the RKE keypress.

15. The method of claim 10, where establishing comprises:
establishing an alarm control action as the primary action for the RKE keypress.

16. The method of claim 10, further comprising:
receiving an RKE location message, and where the control logic determines the RKE controller location based on the RKE location message.

17. A product comprising:
a machine readable medium; and
instructions stored on the medium which cause a remote keyless entry system to:
receive an RKE controller keypress message;
determine an RKE controller location; and
initiate one of a primary action and a secondary action in response to the RKE controller keypress message based on the RKE controller location.

18. The product of claim 17, where the instructions further cause the remote keyless entry system to:
receive an RKE location message; and
determine the RKE controller location based on the RKE location message.

19. The product of claim 18, where the RKE controller location is ‘Inside Vehicle’.

20. The product of claim 18, where the secondary action is an entertainment device control action.

21. The product of claim 20, where the entertainment device control action is an audio system control action.

22. The product of claim 17, where the primary action is a door lock action, an engine start action, an alarm arming action, or a trunk unlock action.

23. A remote keyless entry system comprising:
an automotive bus interface;
a wireless receiver;
a controller coupled to the automotive bus interface and the wireless receiver;
a memory coupled to the controller, the memory including:
a primary mapping from RKE keypresses to primary actions;
a secondary mapping from the RKE keypresses to secondary actions;
a multifunction control program for execution by the controller comprising instructions which:
receive an RKE location message;
determine an RKE controller location based on the RKE location message;
receive an RKE controller keypress message;
extract an RKE keypress identifier from the keypress message;
when the RKE controller location is ‘Inside Vehicle’:
select from the secondary actions in the secondary mapping based on the RKE keypress;
initiate transmission of a corresponding secondary action message through the automotive bus interface;
when the RKE controller location is ‘Outside Vehicle’:
select from the primary actions in the primary mapping based on the RKE keypress; and
initiate transmission of a corresponding primary action message through the automotive bus interface.

24. The remote keyless entry system of claim 23, where the secondary actions comprise an entertainment system control action.

25. The remote keyless entry system of claim 24, where the entertainment system control action is a volume control action.

26. The remote keyless entry system of claim 24, where the entertainment system control action is a play or pause control action.

27. The remote keyless entry system of claim 23, where the RKE location message comprises a vehicle interior wireless transmitter identifier.

28. The remote keyless entry system of claim 25, where the primary actions comprise a door lock, door unlock, or an engine start action.

29. The remote keyless entry system of claim 26, where the primary actions comprise a door lock, door unlock, or an engine start action.

30. The remote keyless entry system of claim 25, where:
the secondary mapping comprises a mapping between the RKE keypresses and secondary actions for multiple vehicle accessories.
